(19) United States
(12) Patent Application Publication
(10) Pub. No.: US 2009/0308553 A1
(43) Pub. Date: Dec. 17, 2009

(54) Method for Treating Mineral Materials Using Amphoteric Polymers, Mineral Materials Thereby Obtained, and their Usage as an Agent for Reducing the Quantity of Colloids in Manufacturing Paper

(75) Inventors: Renaud Souzy, Caluire (FR); Christian Jacquemet, Lyon (FR); Jacques Mongoin, Quincieux (FR)

Correspondence Address: AMSTER, ROTHSTEIN & EBENSTEIN LLP, 90 PARK AVENUE, NEW YORK, NY, 10016, US

(73) Assignee: COATEX S.A.S., Genay (FR)

(21) Appl. No.: 12/226,127

(22) PCT Filed: Apr. 18, 2007
(86) PCT No.: PCT/IB2007/001109

§ 371 Date: Oct. 23, 2008

(30) Foreign Application Priority Data
Apr. 27, 2006 (FR) 06 03774
Sep. 7, 2006 (FR) 06 07815

(51) Int. Cl. D21H 17/34; D21H 17/33; D21H 17/37; D21H 17/45; C08L 43/02; C08L 33/00; C08L 41/00; C08L 33/26; C08L 39/00; C08K 3/26; C08K 3/34; C08K 3/30; C08K 3/22; C08K 3/08; C08K 3/10

(52) U.S. Cl. 162/164.5; 162/164.1; 162/168.1; 162/168.7; 162/168.2; 162/168.3; 524/543; 524/556; 524/547; 524/555; 524/548; 524/436; 524/451; 524/447; 524/423; 524/433; 524/439; 524/437

(57) ABSTRACT

The invention firstly discloses a new method for treating mineral materials, by means of an amphoteric polymer, to make said mineral materials effective as an agent for reducing the quantity of natural and organic colloids in the process of manufacturing a sheet of paper.

A second object of the invention resides in the mineral materials thereby treated and obtained using the inventive method.

The third, fourth, and fifth objects of the invention are the dry powders, aqueous suspensions, and granulated treated mineral materials obtained using the inventive method.

A final object of the invention is the usage of said mineral materials treated using the inventive method as an agent for reducing the quantity of natural and organic colloids in the process for manufacturing sheets of paper.

The invention firstly discloses a new method for treating mineral materials, particular talc and/or chemical and/or mechanically modified synthetic or natural calcium carbonate, by means of at least one amphoteric polymer, for the purpose of improving the capacity of said mineral materials to reduce the quantity of natural and organic colloids in the process for manufacturing sheets of paper.

A second object of the invention resides in the mineral materials thereby treated and obtained using the inventive method.

The third, fourth, and fifth objects of the invention are the dry powders, aqueous suspensions, and granulated treated mineral materials obtained using the inventive method.

A final object of the invention is the usage of said mineral materials treated using the inventive method as an agent for reducing the quantity of natural and organic colloids in the process for manufacturing sheets of paper.

The process for manufacturing a sheet of paper (herein denoted using the term “papermaking process”) generates a large number of colloidal species made up of hydrophobic particles that are wholly or partially insoluble in water. These colloids are either of natural original, and are made up of a large variety of macromolecules with long hydrophobic chains (based on fatty acids, esters, alcohols, etc.), commonly known as “pitch”, to use the term well-known to a person skilled in the art; or are of synthetic origin, and are made up of sticky polymers which are frequently encountered in the papermaking industry, commonly known as “stickies”, to use the other term well-known to a person skilled in the art. Both are totally undesirable, because they stick to the equipment used in the papermaking process (such as the rollers), which requires frequent shutdowns for cleaning, and additionally, there is a risk that they may be found in the end product, where they create surface flows that may endanger the properties of the sheet of paper, such as its whiteness, its mechanical properties, or its surface appearance. They are referred to herein by the term “undesirable colloids”. Such undesirable colloids are also found in pulp, with fibers, or in the white water used in the process for manufacturing a sheet of paper.

There are two types of methods for reducing the quantity of undesirable colloids: those which introduce an organic polymer as an additive in the papermaking process prior to the manufacture of the sheet of paper, and those which introduce an inorganic material (potentially a polymer-treated one) under the same conditions.

In the first category, a certain number of documents are known to a person skilled in the art, which instruct him on the use of cationic, anionic, non-ionic, or amphoteric polymers.

In this manner, patent document U.S. Pat. No. 5,989,392 describes the implementation of cationic polymers, which are quaternary polyammoniums made up of a cationic monomer and a cross-linking monomer, for the purpose of reducing the quantity of undesirable colloids in the paper pulp.

The person skilled in the art also knows the patent document WO 01/88264, which describes the usage of acrylamide- and vinyl acetate-based non-ionic polymers to reduce sticky matter deposits on papermaking machinery.

He also knows patent document U.S. Pat. No. 6,051,160, which describes a liquid compound based on a mixture of guar gum and an anionic styrene maleic anhydride copolymer having a molecular weight between 500 and 10,000 g/mole; this compound is used as an agent for limiting the presence of undesirable colloids in the process for manufacturing a sheet of paper.

The person skilled in the art also knows documents that implement amphoteric polymers to reduce the proportion of undesirable colloids. In this manner, the patent document EP 0,464,993 instructs him on the usage of (meth)acrylic acid and diallydimethyl ammonium chloride (DADMAC) copolymers as an agent for controlling pitch in the process for manufacturing a sheet of paper.

Patent document US 2006 000,570 instructs him on the usage of copolymers of acrylic acid and/or acrylamide along with DADMAC for the purpose of reducing the quantity of undesirable colloids.

However, these solutions, which consist of implementing organic polymers directly in the papermaking process, are unsatisfactory for the person skilled in the art: in reality, such polymers have not turned out to be effective enough in significantly reducing the quantity of undesirable colloids.

The second way to limit the quantity of undesirable colloids consists of implementing a mineral additive, potentially one which has been treated.

To that end, the person skilled in the art has for several years known that mineral materials may be implemented for that purpose, particularly including calcium carbonate, as mentioned in the document “Adsorption of anionic dissolved and colloidal substances onto calcium carbonate fillers” (Tappi Journal, 83 (7), 2000, pp 72-73), although talc is the preferred mineral materials for that purpose, as indicated in the document “Talc as pitch control agent in the paper industry” (Kam Pa Gikyoshi, 53 (9), 1999, pp 1133-1142), or in the document “Productivity and quality enhancement of SC papers with talc” (PAPTAC Annual Meeting, 88^{th}, Montreal, QC, Canada, Jan. 29-31, 2002 (2002), Volume C, C103-C107 Publisher: PAPTAC, Montreal, Quebec), which confirms that talc remains the preferred mineral materials for limiting the quantity of undesirable colloids in the process for manufacturing a sheet of paper.

To that end, a certain number of works listed below have been carried out on treatment agents used to improve the ability of talc to limit the quantity of undesirable colloids; the Applicant indicates, however, that she is unaware of any documents dealing with agents for treating mineral materials other than talc, and particularly calcium carbonate, to improve that same property.

In this manner, for the purpose of improving talc's properties as an agent for reducing the quantity of undesirable colloids, the person skilled in the art knows a certain number of documents that implement polymers as agents for treating said talc.

He also knows patent document WO 89/06294, which describes a method for reducing the quantity of undesirable colloids by using talc onto which a cationic polymer is adsorbed, with the resulting particle having a zeta potential greater than or equal to +30 mV. The authors of this document had also already noted that the talc particles treated in this manner using cationic polymers turned out to be more effective as agents for reducing the quantity of undesirable colloids than the cationic polymers themselves (page 15, lines 19-23). The examples indicate that the adsorption of the cationic polymer onto the talc particle occurs during a simple mixing process.

The person skilled in the art also knows patent document US 2003/096,143, which describes a method for improving the wettability of talc and its affinity for cellulose fibers, thereby enabling a reduction of undesirable colloids. This method is based on doubly treating the talc using a metallic hydroxide and a cationic polymer such as polyDADMAC, polyamines, polyethylenimines and cationic starch. This double treatment occurs through mixing an aqueous suspension of talc and the above-mentioned treatment agents.

Finally, the person skilled in the art knows the patent document US 2003/143,144, which describes for method for modifying the surface of talc, the talc thereby modified being capable of usage as an agent for reducing the quantity of undesirable colloids. This modification takes place by bringing an aqueous suspension of talk and a cationic polymer functionalized with a quaternary amine into contact with one another through ordinary mixing.

Although the methods described in the patent documents WO89/06294, US 2003/096,143, and US 2003/143,144 constitute progress in terms of the effectiveness of treated talc particles as agents for reducing the quantity of undesirable colloids when compared to other solutions which simply implement a simple organic polymer as an additive introduced into the process for manufacturing a sheet of paper, these solutions exhibit a significant drawback for the person skilled in the art: they rely on the implementation of a cationic polymer. These cationic polymers have turned out to be both expensive and toxic to aquatic animals when they are discharged into bodies of water with the wastewater resulting from the papermaking process. Indeed, it is well-known that cationic products adsorb more easily onto anionic sites found on the gills of fish. To that end, the document “Wastewater treatment polymers identified as the toxic component of a diamond mine effluent” (Environmental Toxicology and Chemistry, 23(9), 2004, pp. 2234-2242) reiterates the danger that cationic polymers pose to underwater fauna.

As a result, there is a lack of technical solutions enabling the person skilled in the art to have access to a method for reducing undesirable colloids, in the process for manufacturing a sheet of paper, said method by necessity being more effective than the methods implementing polymers as simple additives, and said method by necessity exhibiting none of the drawbacks inherent in using cationic polymers.

Additionally, pursuing her research into providing the person skilled in the art with such a technical solution, the Applicant has formulated a method for treating mineral materials using polymers, said polymers being brought into contact with said mineral materials:
during a step of mixing with an aqueous suspension of mineral materials, potentially containing pulp of a mechanical and/or thermo-mechanical and/or chemical nature and/or recycled pulp,
and/or during a step of suspending mineral materials, initially present in the form of dry powder, into an aqueous suspension,
and/or during a step of grinding mineral materials, in a dry or aqueous medium,
and/or during a step of drying an aqueous suspension of mineral materials,
and/or during a step of granulating mineral materials,
   characterized in that the polymers are amphoteric polymers, made up of:
a) at least one anionic monomer,
b) at least one cationic monomer,
c) and potentially at least one non-ionic monomer.

In this manner, a treated mineral material that proves to be an effective agent for reducing undesirable colloids in the papermaking process is obtained, which was not the case for the solutions in the prior art, which only implemented a simple polymer or mixture of polymers (this property will be depicted in the examples found herein). Furthermore, the solution disclosed in this manner has proven to be less expensive and less dangerous (ecotoxicologically speaking) than the solutions relying upon the use of a cationic polymer as an agent for treating the mineral material.

Additionally, the Applicant has noted that amphoteric polymers implemented in this invention make it possible, for mineral materials and in particular for any talc and/or calcium carbonate whatsoever (meaning, in particular, regardless of its grain size and specific surface area, or whether it had been chemically or mechanically modified), to treat said mineral material in order to improve its properties as an agent for reducing undesirable colloids: in this way, the amphoteric polymers implemented according to the invention can be used to dope the properties of the undesirable colloid reducing agent for mineral materials, and in particular for any talc and/or calcium carbonate whatsoever. (The Applicant notes that, by the expression “a chemically or mechanically modified talc and/or calcium carbonate”, she is, in the vocabulary well-known to a person skilled in the art, referring to a talc and/or carbonate that has undergone at least one step of chemical modification—such as treatment using an acid—and/or at least one step of mechanical modification—such as grinding or delaminating—without these examples limiting the nature of said chemical and/or mechanical modification).

Finally, the method developed by the Applicant has the advantage of being extremely flexible for the person skilled in the art. By contrast, technical solutions that consist of implementing a talc treated by a cationic polymer rely exclusively on treatment methods that simply mix the mineral material in an aqueous suspension with said cationic polymers. However, the person skilled in the art must also deal with a certain number of requirements imposed by the end user, i.e. the paper manufacturer. These requirements may manifest themselves through various singular transformation steps that the mineral material may undergo, before being delivered to the end user. To that end, said mineral material may undergo one or more of the following operations:
a step of mixing, when said mineral material is already present in the form of an aqueous suspension potentially containing pulp, the objective here being to enable the end user to directly treat a mineral material aqueous suspension during the papermaking process,
a step of suspension, when said mineral material is in the form of dry powder, the objective being to deliver a liquid product to the user,
a step of grinding, in a dry medium or aqueous medium, the objective being to provide the end user with a mineral material having a lower particle size and a higher specific surface area,
a step of drying, when said mineral material was in an aqueous suspension, the objective being to deliver a product in the form of a dry powder to the end user,
a step of granulating, the objective being to deliver products in the form of granules to the end user.

However, none of the solutions offered by the prior art enable the person skilled in the art to treat a mineral material, and particularly a talc and/or calcium carbonate, in order to make it more effective at reducing the quantity of undesirable colloids, by introducing an amphoteric polymer during any one of the aforementioned steps: ordinary mixing is extremely limiting for the person skilled in the art.

Finally, though the Applicant has already noted that she is unaware of any documents dealing with the implementation of agents for treating calcium carbonate to improve its properties for reducing the quantity of undesirable colloids, she emphasizes that there are, on the other hand, numerous documents dealing with agents for treating said carbonate (said agents may be polymers, in particular amphoteric polymers). It should be emphasized that these documents do not entirely resolve the same technical problem covered herein, nor do they disclose or suggest the usage of calcium carbonates treated by amphoteric polymers as agents for reducing the quantity of undesirable colloids in the papermaking process.

The Applicant may thereby cite the document U.S. Pat. No. 5,176,797, which describes a method for grinding calcium carbonate and/or kaolin, implementing amphoteric polymers and a paper fiber retaining agent: the objective of this document is to provide an aqueous suspension of calcium carbonate and/or kaolin, without any anionic dispersing agent whose presence would harm the effectiveness of the retention agent, when said suspension is implemented in the manufacturing of a sheet of paper.

The Applicant may also cite the document WO 91/09067, which describes, for the purpose of obtaining a stable aqueous suspension of mineral materials which does not settle and which has a high content of both dry matter and of finely divided mineral materials, the implementation of water-soluble amphoteric polymers as an agent for dispersing and/or grinding said mineral materials.

She may also cite the document EP 1,294,476, which described the usage of a weakly anionic, water-soluble copolymer as a dispersing agent and/or a pigment grinding aid and/or mineral fillers in an aqueous suspension, thereby both providing the aqueous suspensions of said fillers and/or pigments with a low Zeta potential and providing said suspensions with electrosteric stabilization.

She is also aware of the document EP 1,572,764, which describes the usage of a weakly ionic, water-soluble copolymer as an agent to aid in the grinding of mineral materials in an aqueous suspension for obtaining aqueous suspensions of said finer materials, with a dry material concentration that may be high, a low Brookfield Viscosity™ which is stable over time and has the property of exhibiting a pigment surface area whose ionic load, determined by ionic titration, is low.

Finally, she is also aware of the document EP 0,401,790, which treats the problem of obtaining an aqueous suspension of mineral materials that is stable over time, with a high dry matter content, and with a low viscosity: this is a completely different objective than the one covered by this Application, and the person skilled in the art therefore need not consult said document to resolve the problem covered herein. Although my solution, disclosed in this document, consists of implementing certain amphoteric polymers, this document does not contain any objectives which describe or suggest that the implementation of these amphoteric polymers may be used to improve the ability of calcium carbonate to lower the quantity of undesirable colloids in the papermaking process, compared to calcium carbonate untreated by these amphoteric polymers.

Thus, a first object of the invention is a method for treating mineral materials, using at least one polymer, said polymer being brought into contact with said mineral materials:
during a step of mixing with an aqueous suspension of mineral materials, potentially containing pulp of a mechanical and/or thermo-mechanical and/or chemical nature and/or recycled pulp,
and/or during a step of suspending mineral materials, initially present in the form of dry powder, into an aqueous suspension,
and/or during a step of grinding mineral materials, in a dry or aqueous medium,
and/or during a step of drying an aqueous suspension of mineral materials,
and/or during a step of granulating mineral materials,
   characterized in that said polymer is an amphoteric polymer, made up of:
a) at least one anionic monomer,
b) at least one cationic monomer,
c) and potentially at least one non-ionic monomer.

The inventive method is also characterized in that the amphoteric polymer is made up of:
a) at least one anionic monomer which is an anionic ethylene unsaturated monomer with a monocarboxylic function in the acidic or salified state, chosen from among ethylene unsaturated monomer with a monocarboxylic function, and preferentially from among acrylic, methacrylic, crotonic, isocrotonic, or cinnamic acid, or diacide hemiesters such as C₁-C₄ monoesters of maleic or itaconic acids, or chosen from among ethylene unsaturated monomers with a dicarboxylic function in the acidic or salified state, and preferentially from among itaconic, maleic, fumaric, mesaconic, or citraconic acid, or from carboxylic acid anhydrides, such as maleic anhydride, or one chosen from among ethylene unsaturated monomers with a sulfonic function in the acidic or salified state, and preferentially from among acrylamido-2-methyl-2-propane-sulfonic acid, sodium methallylsulfonate, sulfonic vinyl acid, and sulfonic styrene acid, or from among ethylene unsaturated monomers with a phosphoric function in the acidic or salified state, and preferentially from among phosphoric vinyl acid, ethylene glycol methacrylate phosphate, propylene glycol methacrylate phosphate, ethylene glycol acrylate phosphate, propylene glycol acrylate phosphate, and their ethoxylates, or from among ethylene unsaturated monomers with a phosphonic function in the acidic or salified state, and is preferentially phosphonic vinyl acid, or mixtures thereof,
b) at least one cationic monomer chosen from among quaternary ammoniums, and preferentially from among [2-(methacryloyloxy)ethyl] trimethyl ammonium sulfate or chloride, [2-(acryloyloxy)ethyl] trimethyl ammonium sulfate or chloride, [3-(acrylamido) propyl] trimethyl ammonium sulfate or chloride, dimethyl diallyl ammonium sulfate or chloride, [3-(methacrylamido) propyl] trimethyl ammonium sulfate or chloride, or mixtures thereof,
c) potentially at least one non-ionic monomer chosen from among N-[3-(dimethylamino) propyl] acrylamide or N-[3-(dimethylamino) propyl]methacrylamide, unsaturated esters such as N-[2-(dimethylamino) ethyl]methacrylate, or N-[2-(dimethylamino) ethyl] acrylate; or from among acrylamide or methacrylamide and mixtures thereof, alkyl acrylates or methacrylates, vinyls, and preferentially vinyl acetate, vinylpyrrolidone, styrene, alphamethylstyrene and their derivatives, or formula (I) monomers:

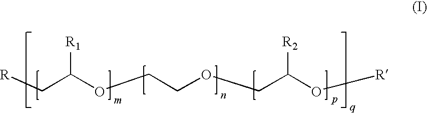

in which:
m and p represent a number of alkylene oxide units less than or equal to 150,
n represents a number of ethylene oxide units less than or equal to 150,
q represents an integer greater than or equal to 1, such as 5≦(m+n+p)q≦150, and preferentially one such as 15≦(m+n+p)q≦120,
R₁ represents hydrogen or the methyl or ethyl radical,
R₂ represents hydrogen or the methyl or ethyl radical,
R represents a radical containing a polymerizable unsaturated function, preferentially belonging to the group of vinyls as well as to the group of acrylic, methacrylic, maleic, itaconic, crotonic, and vinylphtalic esters, as well as to the group of unsaturated urethanes such as acrylurethane, methacrylurethane, α-α′ dimethyl-isopropenyl-benzylurethane, allyl urethane, as well as to the group of allyl or vinyl esters, whether substitutes or not, or to the group of ethylene-unsaturated amides or imides,
R′ represents hydrogen or a hydrocarbon radical with 1 to 40 carbon atoms.

The inventive method is also characterized in that the amphoteric polymer is made up of:
a) at least one anionic monomer, in a proportion of 10% to 90%, preferentially 25% to 75%, and very preferentially 40% to 60% by molar weight,
b) at least one cationic monomer, in a proportion of 10% to 90%, preferentially 25% to 75%, and very preferentially 40% to 60% by molar weight,
c) and at least one non-ionic monomer, in a proportion of 0% to 30%, and preferentially 0% to 20% by molar weight,
   the sum of molar weight percentages for each monomer that makes up said amphoteric polymer being equal to 100%.

The inventive method is also characterized in that the amphoteric polymers are obtained through known radical polymerization methods in solutions, in direct or invert emulsions, in suspensions or through precipitation in appropriate solvents, in the presence of known catalyst systems and transfer agents, or through mediated radical polymerization methods, preferentially through nitroxide-mediated polymerization (NMP) or cobaloxyme-mediated polymerization, atom transfer radical polymerization (ATRP), or sulfur derivative-mediated radical polymerization, said sulfur derivatives being chosen from among carbamates, dithioesters, or trithiocarbonates (RAFT), or xanthates.

The inventive method is also characterized in that the amphoteric polymers are totally acidic, or totally or partially neutralized by a neutralization agent chosen from among sodium hydroxides, potassium hydroxides, calcium oxides and/or hydroxides, magnesium oxides and/or hydroxides, ammonia, or mixtures thereof, preferentially by a neutralization agent chosen from among sodium hydroxide, potassium hydroxide, ammonia, or mixtures thereof, and very preferentially by a neutralization agent which is ammonia.

The inventive method is also characterized in that the amphoteric polymers may, potentially before or after their total or partial neutralization, be treated and separated in multiple phases, using static or dynamic methods known to a person skilled in the art, by means of one or more polar solvents that preferentially belong to the group made up of water, methanol, ethanol, propanol, isopropanol, butanols, acetone, tetrahydrofurane, or mixtures thereof. One of the two phases then corresponds to the polymers used in accordance with the invention.

The inventive method is also characterized in that the amphoteric polymers may be dried.

Finally, the inventive method is also characterized in that the mineral materials are chosen from among natural or precipitated calcium carbonate and talc, said calcium carbonate and talc potentially being chemically and/or mechanically modified, dolomites, kaolin, gypsum, lime, magnesium, titanium dioxide, satin white, aluminum trioxide or aluminum trihydroxide, silicas, mica, barium carbonate, barium sulfate, and any mixtures thereof, such as talc-calcium carbonate, calcium carbonate-kaolin, or mixtures of calcium carbonate with aluminum trihydroxide or aluminum trioxide, or mixtures with synthetic or natural fibers or mineral costructures such as talc-calcium carbonate or talc-titanium dioxide costructures, or mixtures thereof, and preferentially in that they are chosen from among natural or precipitated calcium carbonate and talc, said calcium carbonate and talc potentially being chemically and/or mechanically modified, or mixtures thereof, and in that these mineral materials are very preferentially talc, potentially chemically and/or mechanically modified.

A second object of the invention is constituted by the treated mineral materials, characterized in that the treatment agent is an amphoteric polymer, made up of:
a) at least one anionic monomer,
b) at least one cationic monomer,
c) and potentially at least one non-ionic monomer.

Said mineral materials are also characterized in that said amphoteric polymer is made up of:
a) at least one anionic monomer which is an anionic ethylene unsaturated monomer with a monocarboxylic function in the acidic or salified state, chosen from among ethylene unsaturated monomer with a monocarboxylic function, and preferentially from among acrylic, methacrylic, crotonic, isocrotonic, or cinnamic acid, or diacide hemiesters such as C₁-C₄ monoesters of maleic or itaconic acids, or chosen from among ethylene unsaturated monomers with a dicarboxylic function in the acidic or salified state, and preferentially from among itaconic, maleic, fumaric, mesaconic, or citraconic acid, or from carboxylic acid anhydrides, such as maleic anhydride, or one chosen from among ethylene unsaturated monomers with a sulfonic function in the acidic or salified state, and preferentially from among acrylamido-2-methyl-2-propane-sulfonic acid, sodium methallylsulfonate, sulfonic vinyl acid, and sulfonic styrene acid, or from among ethylene unsaturated monomers with a phosphoric function in the acidic or salified state, and preferentially from among phosphoric vinyl acid, ethylene glycol methacrylate phosphate, propylene glycol methacrylate phosphate, ethylene glycol acrylate phosphate, propylene glycol acrylate phosphate, and their ethoxylates, or from among ethylene unsaturated monomers with a phosphonic function in the acidic or salified state, and is preferentially phosphonic vinyl acid, or mixtures thereof,
b) at least one cationic monomer chosen from among quaternary ammoniums, and preferentially from among [2-(methacryloyloxy)ethyl] trimethyl ammonium sulfate or chloride, [2-(acryloyloxy)ethyl] trimethyl ammonium sulfate or chloride, [3-(acrylamido) propyl] trimethyl ammonium sulfate or chloride, dimethyl diallyl ammonium sulfate or chloride, [3-(methacrylamido) propyl] trimethyl ammonium sulfate or chloride, or mixtures thereof,
c) potentially at least one non-ionic monomer chosen from among N-[3-(dimethylamino) propyl] acrylamide or N-[3-(dimethylamino) propyl]methacrylamide, unsaturated esters such as N-[2-(dimethylamino) ethyl]methacrylate, or N-[2-(dimethylamino) ethyl] acrylate; or from among acrylamide or methacrylamide and mixtures thereof, alkyl acrylates or methacrylates, vinyls, and preferentially vinyl acetate, vinylpyrrolidone, styrene, alphamethylstyrene and their derivatives, or formula (I) monomers:

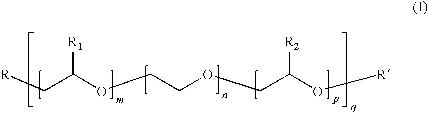

in which:
m and p represent a number of alkylene oxide units less than or equal to 150,
n represents a number of ethylene oxide units less than or equal to 150,
q represents an integer greater than or equal to 1, such as 5≦(m+n+p)q≦150, and preferentially one such as 15≦(m+n+p)q≦120,
R₁ represents hydrogen or the methyl or ethyl radical,
R₂ represents hydrogen or the methyl or ethyl radical,
R represents a radical containing a polymerizable unsaturated function, preferentially belonging to the group of vinyls as well as to the group of acrylic, methacrylic, maleic, itaconic, crotonic, and vinylphtalic esters, as well as to the group of unsaturated urethanes such as acrylurethane, methacrylurethane, α-α′ dimethyl-isopropenyl-benzylurethane, allyl urethane, as well as to the group of allyl or vinyl esters, whether substitutes or not, or to the group of ethylene-unsaturated amides or imides,
R′ represents hydrogen or a hydrocarbon radical with 1 to 40 carbon atoms.

Said mineral materials are also characterized in that said amphoteric polymer is made up of:
a) at least one anionic monomer, in a proportion of 10% to 90%, preferentially 25% to 75%, and very preferentially 40% to 60% by molar weight,
b) at least one cationic monomer, in a proportion of 10% to 90%, preferentially 25% to 75%, and very preferentially 40% to 60% by molar weight,
c) and at least one non-ionic monomer, in a proportion of 0% to 30%, and preferentially 0% to 20% by molar weight,
   the sum of molar weight percentages for each monomer that makes up said amphoteric polymer being equal to 100%.

Said mineral materials are also characterized in that the amphoteric polymers are obtained through known radical polymerization methods in solutions, in direct or invert emulsions, in suspensions or through precipitation in appropriate solvents, in the presence of known catalyst systems and transfer agents, or through mediated radical polymerization methods, preferentially through nitroxide-mediated polymerization (NMP) or cobaloxyme-mediated polymerization, atom transfer radical polymerization (ATRP), or sulfur derivative-mediated radical polymerization, said sulfur derivatives being chosen from among carbamates, dithioesters, or trithiocarbonates (RAFT), or xanthates.

Said mineral materials are also characterized in that the amphoteric polymers are totally acidic, or totally or partially neutralized by a neutralization agent chosen from among sodium hydroxides, potassium hydroxides, calcium oxides and/or hydroxides, magnesium oxides and/or hydroxides, ammonia, or mixtures thereof, preferentially by a neutralization agent chosen from among sodium hydroxide, potassium hydroxide, ammonia, or mixtures thereof, and very preferentially by a neutralization agent which is ammonia.

Said mineral materials are also characterized in that the amphoteric polymers may, potentially before or after their total or partial neutralization, be treated and separated in multiple phases, using static or dynamic methods known to a person skilled in the art, by means of one or more polar solvents that preferentially belong to the group made up of water, methanol, ethanol, propanol, isopropanol, butanols, acetone, tetrahydrofurane, or mixtures thereof. One of the two phases then corresponds to the polymers used in accordance with the invention.

The treated talc is also characterized in that the amphoteric polymers may be dried.

Finally, the inventive mineral materials are also characterized in that the mineral materials are chosen from among natural or precipitated calcium carbonate and talc, said calcium carbonate and talc potentially being chemically and/or mechanically modified, dolomites, kaolin, gypsum, lime, magnesium, titanium dioxide, satin white, aluminum trioxide or aluminum trihydroxide, silicas, mica, barium carbonate, barium sulfate, and any mixtures thereof, such as talc-calcium carbonate, calcium carbonate-kaolin, or mixtures of calcium carbonate with aluminum trihydroxide or aluminum trioxide, or mixtures with synthetic or natural fibers or mineral costructures such as talc-calcium carbonate or talc-titanium dioxide costructures, or mixtures thereof, and preferentially in that they are chosen from among natural or precipitated calcium carbonate and talc, said calcium carbonate and talc potentially being chemically and/or mechanically modified, or mixtures thereof, and in that these mineral materials are very preferentially talc, potentially chemically and/or mechanically modified.

A third object of the invention is a dry powder of treated mineral materials, characterized in that the treated mineral materials are the inventive mineral materials.

A fourth object of the invention is granulated treated mineral materials, characterized in that the treated mineral materials are the inventive mineral materials.

A fifth object of the invention is an aqueous suspension of treated mineral materials, potentially containing pulp of a mechanical and/or thermo-mechanical and/or chemical nature and/or recycled pulp, characterized in that the treated mineral materials are the inventive mineral materials.

A sixth and final object of the invention is the usage of inventive treated mineral materials, an inventive dry powder of treated mineral materials, inventive granulated treated mineral materials, and an inventive aqueous suspension of treated mineral materials as an agent for reducing the quantity of undesirable colloids in the process of manufacturing a sheet of paper.

### EXAMPLES

In all examples, the polymolecularity indices and average molecular weights of the polymers (when measured) are determined using the following method.

The average molecular weights and polymolecularity index are determined using a steric exclusion chromatography (SEC) method. A test sample of the polymer solution corresponding to 90 mg of dry matter is added to a 10 ml flask. The mobile phase is added, with an additional 0.04% THF, until a total mass of 10 g is attained. The composition of this mobile phase is as follows: NaNO₃: 0.2 mol/L, CH₃COOH: 0.5 mol/L, acetonitrile 5% volume. The SEC system is made up of a Waters™ 510 isocratic pump, whose flow is set to 0.8 mL/min, a Waters 717+ auto-sampler, an oven containing a “Guard Column Ultrahydrogel Waters™” precolumn, followed by a set of “Ultrahydrogel Waters™” columns having an internal diameter of 7.8 mm and a length of 30 cm, and whose rated porosities are, in the order in which they are connected: 2000, 1000, 500 and 250 Å. Detection is provided by a Waters™ 410 differential refractometer. The temperature of the oven and the detector is set to 35° C. The chromatogram is taken and processed using the software PSS WinGPC Scientific v 4.02. The SEC is calibrated using a series of poly(DADMAC) standards provided by Polymer Standards Service™. The calibration curve is linear, and takes into account the correction determined using the flow marker (THF).

### Example 1

This example depicts the inventive method, wherein an amphoteric polymer is implemented to treat a mineral material, which is a talc, during a step of suspending said talc in an aqueous suspension (this step of suspension being carried out using techniques which are well known to a person skilled in the art).

The talc used is Finntalc™ P05, sold by the company MONDO MINERALS, having a median diameter equal to 2.2 μm (as determined using a Sedigraph™ 5100 device sold by the company MICROMERITICS™) and a BET specific surface area equal to 10.0 m²/g (as measured using a Flowsorb™ II device sold by the company MICROMERITICS™).

### Test #1

This test constitutes a reference.

Mechanical wood pulp, obtained from La Papeterie in Lancey, France, is filtered through a filter whose pore diameter is equal to 2 μm.

This wood pulp has a solids content of 12 g/L, and a particular concentration equal to 65×10⁶ particles per cm³, measured using a metering console sold by the company NEUBAUER™.

A liquor is thereby obtained.

20 g of water is added to 200 g of said liquor.

The liquid phase is then centrifuged at 3000 rpm for 15 minutes, and its turbidity is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #2

This test illustrates the prior art.

An aqueous suspension of talc is created, containing 40% untreated talc by dry weight compared to the total weight of said suspension.

10 g of the suspension thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #3

This test illustrates the invention.

An aqueous dispersion of talc, containing 40% talc by dry weight, is created in the presence of 1% by dry weight (measured with respect to the dry weight of the talc) of an amphoteric polymer made up 50%, by molar weight, of MAPTAC ([3-(methacrylamido) propyl] trimethyl ammonium chloride) and 50%, by molar weight, of acrylic acid.

Its molecular mass in weight is equal to 44,200 g/mole, and its polymolecularity index is equal to 1.95.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #4

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT ([2-(methacryloyloxy)ethyl] trimethyl ammonium chloride) and 40%, by molar weight, of acrylic acid.

Its molecular mass in weight is equal to 78,000 g/mole, and its polymolecularity index is equal to 2.65.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

The set of characteristics and findings corresponding to tests #1-4 is given in table 1.

For each test, the difference between the 1000 mV value (the calibration value of the phototrode when it is submerged into bi-permutated water) and the turbidity value measured for every test is calculated: the lower this difference is, the lower the quantity of undesirable colloids remaining in the sample is.

TABLE 1

| | Test # | | | |
|---|---|---|---|---|
| | 1 | 2 | 3 | 4 |
| Reference/Prior | Reference | Prior Art | Invention | Invention |
| Art/Invention | | | | |
| Mechanical pulp (g) | 200 | 200 | 200 | 200 |
| Water added to the pulp | 20 | 10 | 10 | 10 |
| (g) | | | | |
| Aqueous suspension | 0 | 10 | 10 | 10 |
| containing 40% talc | | | | |
| by dry weight (g) | | | | |
| Amphoteric polymer | 0 | 0 | 1 | 1 |
| (% by dry weight/dry | | | | |
| weight of talc) | | | | |
| 1000 - turbidity value | 690 | 150 | 60 | 30 |
| (mV) | | | | |

These findings show that the talc used in test #3 makes it possible to reduce the quantity considerably (1000−turbidity value).

However, the most favorable findings are obtained in tests #3 and 4, which, in accordance with the invention, implement an amphoteric polymer as an agent for treating said talc, and which make it possible to enhance said talc's effectiveness.

These findings therefore show the effectiveness of the polymers of the invention, as talc treatment agents, for the purpose of making them effective at reducing the quantity of undesirable colloids in a process for manufacturing a sheet of paper.

### Example 2

This example illustrates the inventive method, wherein an amphoteric polymer is used to treat a mineral material, which is a talc, during a step of suspending said talc in an aqueous suspension.

The talc used is Finntalc™ P15, sold by the company MONDO MINERALS, having a median diameter equal to 5.5 μm (as determined using a Sedigraph™ 5100 device sold by the company MICROMERITICS™) and a BET specific surface area equal to 6.0 m²/g (as measured using a Flowsorb™ II device sold by the company MICROMERITICS™).

For this series of tests, test #1 continues to serve as the reference.

In addition to the turbidimetry measurement carried out during test #1, a chemical oxygen demand (COD) measurement is also carried out, with this measurement representing the concentration (mg/L) of oxygen equivalent to the quantity of dichromate consumed by the dissolved suspended materials (1 mole of K₂Cr₂O₇ corresponds to 1 mole of oxygen).

The COD measurement is taken in accordance with ISO 6060, using a Spectroquant Nova 60 photometer sold by the company MERCK™.

This measurement is representative of the quantity of undesirable colloids that remain in the liquid phase: the higher this value is, the greater the quantity of undesirable colloids remains suspended.

### Test #5

This test illustrates the prior art.

An aqueous suspension of talc is created, containing 40% talc by dry weight compared to the total weight of said suspension.

10 g of the suspension thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

A COD measurement is also carried out on the liquid phase, using the method described above.

### Test #6

This test illustrates the invention.

An aqueous dispersion of talc, containing 40% talc by dry weight, is created in the presence of 1% by dry weight (measured with respect to the dry weight of the talc) of an amphoteric polymer made up 50%, by molar weight, of MAPTAC, and 50%, by molar weight, of acrylic acid.

Its molecular mass in weight is equal to 44,200 g/mole, and its polymolecularity index is equal to 1.95.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

A COD measurement is also carried out on the liquid phase, using the method described above.

### Test #7

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, and 40%, by molar weight, of acrylic acid.

Its molecular mass in weight is equal to 78,000 g/mole, and its polymolecularity index is equal to 2.65.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

A COD measurement is also carried out on the liquid phase, using the method described above.

### Test #8

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, and 40%, by molar weight, of acrylic acid.

Its molecular mass in weight is equal to 121,000 g/mole; and its polymolecularity index is equal to 2.20.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

A COD measurement is also carried out on the liquid phase, using the method described above.

### Test #9

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, and 40%, by molar weight, of acrylic acid.

Its molecular mass in weight is equal to 54,500 g/mole, and its polymolecularity index is equal to 2.45.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

A COD measurement is also carried out on the liquid phase, using the method described above.

The set of characteristics and findings corresponding to tests #1 and 5-9 is given in table 2.

TABLE 2

| | Test # | | | | | |
|---|---|---|---|---|---|---|
| | 1 | 5 | 6 | 7 | 8 | 9 |
| Reference/ | Reference | Prior Art | Invention | Invention | Invention | Invention |
| Prior | | | | | | |
| Art/Invention | | | | | | |
| Mechanical | 200 | 200 | 200 | 200 | 200 | 200 |
| pulp (g) | | | | | | |
| Water added | 20 | 10 | 10 | 10 | 10 | 10 |
| to the pulp (g) | | | | | | |
| Aqueous | 0 | 10 | 10 | 10 | 10 | 10 |
| suspension | | | | | | |
| containing | | | | | | |
| 40% talc by | | | | | | |
| dry weight (g) | | | | | | |
| Amphoteric | 0 | 0 | 1 | 1 | 1 | 1 |
| polymer (% | | | | | | |
| by dry | | | | | | |
| weight/dry | | | | | | |
| weight of | | | | | | |
| talc) | | | | | | |
| 1000 - | 690 | 180 | 70 | 55 | 50 | 60 |
| turbidity | | | | | | |
| value (mV) | | | | | | |
| COD (mg/L) | 3400 | 3050 | 2375 | 2680 | 2680 | 2680 |

These findings show that the talc used in test #5 makes it possible to considerably lower the quantity (1000−turbidity value), while reducing the COD value.

The most favorable findings, however, are obtained from tests #6-9, which, in accordance with the invention, implement an amphoteric polymer as an agent for treating said talc, and which make it possible to enhance said talc's effectiveness, lowering both the quantity (1000−turbidity value) and the COD.

These findings therefore show the effectiveness of the polymers of the invention, as talc treatment agents, for the purpose of making them effective at reducing the quantity of undesirable colloids in a process for manufacturing a sheet of paper.

### Example 3

This example illustrates the inventive method, wherein an amphoteric polymer is used to treat a mineral material, which is a talc, during a step of suspending said talc in an aqueous suspension.

The talc used is a Finnish talc having a median diameter equal to 30 μm (as determined using a Sedigraph™ 5100 device sold by the company MICROMERITICS™) and a BET specific surface area equal to 3.4 m²/g (as measured using a Flowsorb™ II device sold by the company MICROMERITICS™).

For this series of tests, test #1 continues to serve as the reference.

### Test #10

This test illustrates the prior art.

An aqueous suspension of talc is created, containing 40% talc by dry weight compared to the total weight of said suspension.

10 g of the suspension thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #11

This test illustrates the invention.

An aqueous dispersion of talc, containing 40% talc by dry weight, is created in the presence of 1% by dry weight (measured with respect to the dry weight of the talc) of an amphoteric polymer made up 50%, by molar weight, of MADQUAT and 50%, by molar weight, of acrylic acid.

Its molecular mass in weight is equal to 84,400 g/mole, and its polymolecularity index is equal to 3.1.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #12

This test illustrates the invention.

An aqueous dispersion of talc, containing 40% talc by dry weight, is created in the presence of 1% by dry weight (measured with respect to the dry weight of the talc) of an amphoteric polymer made up 50%, by molar weight, of MAPTAC, and 50%, by molar weight, of acrylic acid.

Its molecular mass in weight is equal to 44,200 g/mole, and its polymolecularity index is equal to 1.95.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #13

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, and 40%, by molar weight, of acrylic acid.

Its molecular mass in weight is equal to 78,000 g/mole, and its polymolecularity index is equal to 2.55.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #14

This test illustrates the invention.

An aqueous dispersion of talc, containing 40% talc by dry weight, is created in the presence of 1% by dry weight (measured with respect to the dry weight of the talc) of an amphoteric polymer made up 10%, by molar weight, of MAPTAC, and 40%, by molar weight, of acrylic acid.

Its molecular mass in weight is equal to 56,000 g/mole, and its polymolecularity index is equal to 2.55.

10 g of the dispersion thereby obtained is mixed with 200 g of the liquor described in test 1, as well as with 10 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

The set of characteristics and findings corresponding to tests #10-14 is given in table 3.

TABLE 3

| | Test # | | | | | |
|---|---|---|---|---|---|---|
| | 1 | 10 | 11 | 12 | 13 | 14 |
| Reference/Prior | Reference | Prior Art | Invention | Invention | Invention | Invention |
| Art/ | | | | | | |
| Invention | | | | | | |
| Mechanical | 200 | 200 | 200 | 200 | 200 | 200 |
| pulp (g) | | | | | | |
| Water added to | 20 | 10 | 10 | 10 | 10 | 10 |
| the pulp (g) | | | | | | |
| Aqueous | 0 | 10 | 10 | 10 | 10 | 10 |
| suspension | | | | | | |
| containing 40% | | | | | | |
| talc by dry | | | | | | |
| weight (g) | | | | | | |
| Amphoteric | 0 | 0 | 1 | 1 | 1 | 1 |
| polymer (% by | | | | | | |
| dry weight/dry | | | | | | |
| weight of talc) | | | | | | |
| 1000 - turbidity | 690 | 680 | 250 | 70 | 30 | 225 |
| value (mV) | | | | | | |

These findings show that the talc used in test #10 only makes a very small reduction in the quantity of the value possible (1000−turbidity value): such an untreated talc does not prove to be an effective agent for reducing the quantity of undesirable colloids in the papermaking process.

However, all of the findings obtained by using amphoteric polymers in accordance with the invention as an agent for treating said talc lead to values whose quantity is much lower (1000−turbidity value), when compared to the reference: these findings therefore show that the talc treated in this manner by amphoteric polymers does constitute a very effective agent for reducing the quantity of undesirable colloids in the papermaking process.

### Example 4

This example illustrates the inventive method, wherein an amphoteric polymer is used to treat a mineral material, which is a talc, during a step of grinding said talc in an aqueous medium.

The talc used is Comital™ GR45, sold by the company of the same name, having a median diameter equal to 14.6 μm (as determined using a Sedigraph™ 5100 device sold by the company MICROMERITICS™) and a BET specific surface area equal to 3.22 m²/g (as measured using a Flowsorb™ II device sold by the company MICROMERITICS™).

For this series of tests, test #1 continues to serve as the reference.

### Test #15

This test illustrates the prior art.

Grinding is carried out using a Dynomill™ device sold by the company WAB™ in an aqueous phase of talc, containing 40% talc by dry weight with respect to the total weight of said ground suspension. Once grinding is complete, the value of the median diameter is 9 μm (as determined by a Sedigraph™ 5100 device sold by the company MICROMERITICS™).

10 g of water and 10 g of the suspension thereby obtained are mixed with 200 g of the liquor described in test 1, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #16

This test illustrates the invention.

An aqueous dispersion of talc, containing 40% talc by dry weight, is ground using a Dynomill™ device sold by the company WAB™, in the presence of 2%, by dry weight (measured with respect to the dry weight of the talc), of an amphoteric polymer made up 50%, by molar weight, of MAPTAC, and 50%, by molar weight, of acrylic acid.

Its molecular mass in weight is equal to 44,200 g/mole, and its polymolecularity index is equal to 1.95.

Once grinding is complete, the value of the median diameter is 9 μm (as determined by a Sedigraph™ 5100 device sold by the company MICROMERITICS™).

10 g of water and 10 g of the suspension thereby obtained are mixed with 200 g of the liquor described in test 1, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

All characteristics and findings corresponding to tests #15-16 are given in table 4.

TABLE 4

| | Test # | | |
|---|---|---|---|
| | 1 | 15 | 16 |
| | Reference/Prior Art/Invention | | |
| | Reference | Prior Art | Invention |
| Mechanical pulp (g) | 200 | 200 | 200 |
| Water added to the pulp (g) | 20 | 0 | 0 |
| Aqueous suspension obtained by | 0 | 10 | 10 |
| grinding, containing 40% talc | | | |
| by dry weight (g) | | | |
| Water added to the suspension | 0 | 10 | 10 |
| obtained by grinding (g) | | | |
| Amphoteric polymer (% by dry | 0 | 0 | 2 |
| weight/dry weight of talc) | | | |
| 1000 - turbidity value (mV) | 690 | 220 | 40 |

These findings show that the talc used in test #15 makes it possible to reduce the value of the quantity (1000−turbidity value).

However, the most favorable result is obtained with the polymer of test #16: this result therefore shows that the talc treated in this manner by said amphoteric polymer during a step of grinding constitutes a very effective agent for reducing the quantity of undesirable colloids in the papermaking process.

### Example 5

This example illustrated the inventive method, wherein an amphoteric polymer is used to treat a mineral material, which is a natural or precipitated calcium carbonate, during a step of suspending said calcium carbonate.

Test #1 is used as the reference.

### Test #17

This test illustrates the prior art.

An aqueous suspension of natural calcium carbonate is created, containing 40% untreated calcium carbonate, by dry weight, compared to the total weight of said suspension.

The calcium carbonate used is a calcite of Orgon (France) sold by the company OMYA™ under the name BL 200.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #17a

This test illustrates the invention.

An aqueous dispersion of the same calcium carbonate as used in test #17, containing 40% calcium carbonate by dry weight, is created in the presence of 1%, by dry weight (measured with respect to the dry weight of the calcium carbonate) of an amphoteric polymer made up of 60% by molar weight of MADQUAT and 40% by molar weight of acrylic acid.

Its molecular mass in weight is equal to 78,000 g/mole, and its polymolecularity index is equal to 2.55.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #18

This test illustrates the prior art.

An aqueous suspension of natural calcium carbonate is created, containing 40% untreated calcium carbonate, by dry weight, compared to the total weight of said suspension.

The calcium carbonate used is a marble of Carrare (Italy) sold by the company OMYA™ under the name Omyacarb™ 1AV.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #18a

This test illustrates the invention.

An aqueous dispersion of the same natural calcium carbonate as used in test #18, containing 40% calcium carbonate by dry weight, is created in the presence of 1%, by dry weight (measured with respect to the dry weight of the calcium carbonate) of an amphoteric polymer made up of 60% by molar weight of MADQUAT and 40% by molar weight of acrylic acid.

Its molecular mass in weight is equal to 78,000 g/mole, and its polymolecularity index is equal to 2.55.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #19

This test illustrates the prior art.

An aqueous suspension of precipitated calcium carbonate is created, containing 40% untreated calcium carbonate, by dry weight, compared to the total weight of said suspension.

The precipitated calcium carbonate used is Socal™ P3, sold by the company SOLVAY™.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™. DL 70 device equipped with Phototrode™ DP 660, both of these devices being sold by the company METTLER TOLEDO™.

The phototrode has been calibrated to a value of 1000 mV in bipermutated water beforehand.

### Test #19a

This test illustrates the invention.

An aqueous dispersion of the same precipitated calcium carbonate as used in test #19, containing 40% calcium carbonate by dry weight, is created in the presence of 1%, by dry weight (measured with respect to the dry weight of the calcium carbonate) of an amphoteric polymer made up of 60% by molar weight of MADQUAT and 40% by molar weight of acrylic acid.

Its molecular mass in weight is equal to 78,000 g/mole, and its polymolecularity index is equal to 2.55.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #20

This test illustrates the prior art.

An aqueous suspension of chemically modified calcium carbonate is created, containing 40% untreated calcium carbonate, by dry weight, compared to the total weight of said suspension.

The precipitated calcium carbonate used is sold by the company OMYA™ under the name Omyasorb™ 7500; its specific surface area is equal to 38.4 m²/g, as measured using the BET method, and its median diameter is equal to 1.33 μm, as measured using a Sedigraph™ 5100 sold by the company MICROMERITICS™.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a Mettler™ DL 70 device equipped with Phototrode™ DP 660, both of these devices being sold by the company METTLER TOLEDO™.

The phototrode has been calibrated to a value of 1000 mV in bipermutated water beforehand.

### Test #20a

This test illustrates the invention.

An aqueous dispersion of the same calcium carbonate as used in test #20, containing 40% calcium carbonate by dry weight, is created in the presence of 1%, by dry weight (measured with respect to the dry weight of the calcium carbonate) of an amphoteric polymer made up of 60% of MADQUAT by molar weight and 40% acrylic acid by molar weight.

Its molecular mass in weight is equal to 78,000 g/mole, and its polymolecularity index is equal to 2.55.

5 g of the suspension thereby obtained is mixed with 200 g of the liquor described in test 1, as well as with 15 g of water, and the mixture is agitated for 2 hours to react.

The liquid phase is then separated from the solid phase through centrifugation at 3000 rpm for 15 minutes, and the turbidity of the liquid phase is measured using a. Mettler™ DL 70 device equipped with Phototrode™ DP 660, both of these devices being sold by the company METTLER TOLEDO™.

The phototrode has been calibrated to a value of 1000 mV in bipermutated water beforehand.

For each of the tests #17, 17a, 18, 18a, 19, 19a, 20, and 20a, the difference between the 1000 mV value (the calibration value of the phototrode when it is submerged into bi-permutated water) and the turbidity value measured for every test is calculated: the lower this difference is, the lower the quantity of undesirable colloids remaining in the sample is.

All characteristics and findings corresponding to tests #17-20 and #17a-20a are given in table 5.

TABLE 5

| | Test # | | | | | | | | |
|---|---|---|---|---|---|---|---|---|---|
| | 1 | 17 | 17a | 18 | 18a | 19 | 19a | 20 | 20a |
| Reference/Prior | Reference | Prior Art | Inv. | Prior | Inv. | Prior | Inv. | Prior | Inv. |
| Art/Invention | | | | Art | | Art | | Art | |
| Mechanical | 200 | 200 | 200 | 200 | 200 | 200 | 200 | 200 | 200 |
| pulp (g) | | | | | | | | | |
| Water added | 20 | 15 | 15 | 15 | 15 | 15 | 15 | 15 | 15 |
| to the pulp (g) | | | | | | | | | |
| Aqueous | 0 | 5 | 5 | 5 | 5 | 5 | 5 | 5 | 5 |
| suspension | | | | | | | | | |
| containing 40% | | | | | | | | | |
| CaCO₃ by dry | | | | | | | | | |
| weight (g) | | | | | | | | | |
| Amphoteric | 0 | 0 | 1 | 0 | 1 | 0 | 1 | 0 | 1 |
| polymer (% by | | | | | | | | | |
| dry weight/dry | | | | | | | | | |
| weight of | | | | | | | | | |
| CaCO3) | | | | | | | | | |
| 1000 - turbidity | 690 | 585 | 325 | 525 | 110 | 715 | 110 | 785 | 40 |
| value (mV) | | | | | | | | | |

The findings in table 5 show that the natural calcium carbonates and the precipitated calcium carbonate, as well as the chemically modified calcium carbonate, make it possible to reduce the value of the quantity (1000−turbidity value).

When the findings are compared against one another (tests 17 and 17a, tests 18 and 18a, tests 19 and 19a, tests 20 and 20a), one observes that the inventive use of the amphoteric polymer makes it possible to reduce the value of the quantity (1000−turbidity value), and does so to an even greater extent than if said polymer is not used.

### Example 6

This example depicts the inventive method, wherein an amphoteric polymer is implemented to treat a mineral material, which is a talc, during a step of suspending said talc in an aqueous suspension (this step of suspension being carried out using techniques which are well known to a person skilled in the art).

The talc used is Finntalc™ P05, sold by the company MONDO MINERALS, having a median diameter equal to 2.2 μm (as determined using a Sedigraph™ 5100 device sold by the company MICROMERITICS™) and a BET specific surface area equal to 10.0 m²/g (as measured using a Flowsorb™ II device sold by the company MICROMERITICS™).

### Test #21

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, and 40%, by molar weight, of acrylic acid. Its molecular mass in weight is equal to 85,000 g/mole, and its polymolecularity index is equal to 3.1.

### Test #22

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, and 40%, by molar weight, of methacrylic acid. Its molecular mass in weight is equal to 100,000 g/mole, and its polymolecularity index is equal to 3.5.

### Test #23

This test illustrates the invention.

An aqueous dispersion of talc, containing 40% talc by dry weight, is created in the presence of 1% by dry weight (measured with respect to the dry weight of the talc) of an amphoteric polymer made up 60%, by molar weight, of MADQUAT, 20% by molar weight of acrylic acid and 20%, by molar weight, of methacrylic acid. Its molecular mass in weight is equal to 158,000 g/mole, and its polymolecularity index is equal to 3.6.

### Test #24

This test illustrates the invention.

An aqueous dispersion of talc, containing 40% talc by dry weight, is created in the presence of 1% by dry weight (measured with respect to the dry weight of the talc) of an amphoteric polymer made up 50%, by molar weight, of APTAC (acrylamidopropyltrimethyl ammonium chloride), and 50%, by molar weight, of methacrylic acid. Its molecular mass in weight is equal to 92,000 g/mole, and its polymolecularity index is equal to 3.6.

For each of the tests 21 to 24, 10 g of the suspension of talc thereby obtained is mixed with 200 g of the liquor described in test 1 of example 1, as well as with 10 g of water, and the mixture is agitated for 2 hours to react. The liquid phase is then separated from the solid phase through centrifugation at 3000 rpm for 15 minutes, and the turbidity of the liquid phase is measured using a Mettler™ DL 70 device equipped with Phototrode™ DP 660 (previously calibrated to a value of 1000 mV in bi-permutated water). A COD measurement is also carried out on the liquid phase, using the method described in example 2.

All of the characteristics and findings corresponding to tests #21 to 24 are given in table 6, where test #1 is again used as a reference without polymers, and where test #2 again represents the prior art, wherein an untreated talc is used.

TABLE 6

| | Test # | | | | | |
|---|---|---|---|---|---|---|
| | 1 | 2 | 21 | 22 | 23 | 24 |
| Reference/Prior Art/ | Ref | PA | IN | IN | IN | IN |
| Invention | | | | | | |
| Mechanical pulp (g) | 200 | 200 | 200 | 200 | 200 | 200 |
| Water added to the pulp (g) | 20 | 10 | 10 | 10 | 10 | 10 |
| Aqueous suspension | 0 | 10 | 10 | 10 | 10 | 10 |
| containing 40% talc by | | | | | | |
| dry weight (g) | | | | | | |
| Amphoteric polymer(% by | 0 | 0 | 1 | 1 | 1 | 1 |
| dry weight/dry weight of talc) | | | | | | |
| 1000 - turbidity value (mV) | 690 | 150 | 55 | 55 | 55 | 61 |
| COD (mg/L) | 3400 | 3050 | 2700 | 2700 | 2700 | 2780 |

The most favorable findings are obtained in tests #21 to 24, which, in accordance with the invention, use an amphoteric polymer as an agent for treating the talc, and which make it possible to enhance said talc's effectiveness. These findings therefore show the effectiveness of the inventive polymers as talc treatment agents for the purpose of making them effective at reducing the quantity of undesirable colloids in a process for manufacturing a sheet of paper.

### Example 7

This example illustrates the inventive method, wherein an amphoteric polymer is used to treat a mineral material, which is a talc, during a step of granulating said talc.

The talc used is Finntalc™ P05, sold by the company MONDO MINERALS, having a median diameter equal to 2.2 μm (as determined using a Sedigraph™ 5100 device sold by the company MICROMERITICS™) and a BET specific surface area equal to 10.0 m²/g (as measured using a Flowsorb™ II device sold by the company MICROMERITICS™).

The granulated talc is created using a conventional agglomeration method in a fluid bed. The fluidized talc powder is wetted using an aqueous solution (potentially containing the treatment agent) at the intake of the granulation chamber before being extruded, in order to obtain extrudates having a diameter of about 3 to 5 mm, and a length equal to 2 to 3 times their diameter. The aqueous solution (potentially containing the treatment agent) is sprayed into the intake of the granulation chamber, in such a way as to obtain granules containing about 10% humidity and a treatment rate of 1% treatment agent (with respect to the dry talc) in cases when the aqueous solution used contains said treatment agent.

### Test #25

This test illustrates the prior art.

It uses a granulated talc obtained through granulation, with an aqueous solution containing no treatment agent.

4 g of granules are mixed with 200 g of the liquor described in test 1 of example 1, as well as with 10 g of water, and the mixture is agitated for 2 hours to react. The liquid phase is then separated from the solid phase through centrifugation at 3000 rpm for 15 minutes, and the turbidity of the liquid phase is measured using a Mettler™ DL 70 device equipped with Phototrode™ DP 660 (previously calibrated to a value of 1000 mV in bi-permutated water).

### Test #26

This test illustrates the invention.

It uses a granulated talc obtained through granulation with an aqueous solution containing a treatment agent, which is an amphoteric polymer made up of 50% MAPTAC by molar weight and 50% acrylic acid by molar weight. Its molecular mass in weight is equal to 44,200 g/mole, and its polymolecularity index is equal to 1.95.

### Test #27

This test illustrates the invention.

It uses a granulated talc obtained through granulation with an aqueous solution containing a treatment agent, which is an amphoteric polymer made up of 60% MADQUAT by molar weight and 40% acrylic acid by molar weight. Its molecular mass in weight is equal to 78,000 g/mole, and its polymolecularity index is equal to 2.65.

### Test #28

This test illustrates the invention.

It uses a granulated talc obtained through granulation with an aqueous solution containing a treatment agent, which is an amphoteric polymer made up of 60% MADQUAT by molar weight and 40% acrylic acid by molar weight. Its molecular mass in weight is equal to 121,000 g/mole, and its polymolecularity index is equal to 2.20.

For each of the tests 25 to 28, 4 g of the talc granules thereby obtained are mixed with 200 g of the liquor described in test 1 of example 1, as well as with 10 g of water, and the mixture is agitated for 2 hours to react. The liquid phase is then separated from the solid phase through centrifugation at 3000 rpm for 15 minutes, and the turbidity of the liquid phase is measured using a Mettler™ DL 70 device equipped with Phototrode™ DP 660 (previously calibrated to a value of 1000 mV in bi-permutated water). A COD measurement is also carried out on the liquid phase, using the method described in example 2.

The set of characteristics and findings corresponding to tests #25-28 is given in table 7.

TABLE 7

| | Test # | | | | |
|---|---|---|---|---|---|
| | 1 | 25 | 26 | 27 | 28 |
| Reference/Prior Art/ | Ref | PA | IN | IN | IN |
| Invention | | | | | |
| Mechanical pulp (g) | 200 | 200 | 200 | 200 | 200 |
| Water added to the pulp (g) | 20 | 10 | 10 | 10 | 10 |
| Granulated talc (g) | 0 | 4 | 4 | 4 | 4 |
| Amphoteric polymer (% by dry | 0 | 0 | 1 | 1 | 1 |
| weight/dry weight of talc) | | | | | |
| 1000 - turbidity value (mV) | 690 | 200 | 80 | 65 | 50 |
| COD (mg/L) | 3400 | 3250 | 2480 | 2800 | 2620 |

The most favorable findings are obtained in tests #26 to 28, which, in accordance with the invention, use a granulated talc with an amphoteric polymer as an agent for treating the talc, and which make it possible to enhance said granulated talc's effectiveness at reducing the quantity of undesirable colloids in the process for manufacturing a sheet of paper.

1. Method for treating mineral materials with at least one polymer, said polymer being brought into contact with said mineral materials:
during a step of mixing with an aqueous suspension of mineral materials, potentially containing pulp of a mechanical and/or thermo-mechanical and/or chemical nature and/or recycled pulp,
and/or during a step of suspending mineral materials, initially present in the form of dry powder, in an aqueous suspension,
and/or during a step of grinding mineral materials, in a dry or aqueous medium,
and/or during a step of drying an aqueous suspension of mineral materials,
and/or during a step of granulating mineral materials,
characterized in that said polymer is an amphoteric polymer, made up of:
a) at least one anionic monomer,
b) at least one cationic monomer,
c) and potentially at least one non-ionic monomer.

2. A method according to claim 1, characterized in that the amphoteric polymer is made up of:
a) at least one anionic monomer which is an anionic ethylene unsaturated monomer with a monocarboxylic function in the acidic or salified state, chosen from among ethylene unsaturated monomer with a monocarboxylic function, and preferentially from among acrylic, methacrylic, crotonic, isocrotonic, or cinnamic acid, or diacide hemiesters such as C₁-C₄ monoesters of maleic or itaconic acids, or chosen from among ethylene unsaturated monomers with a dicarboxylic function in the acidic or salified state, and preferentially from among itaconic, maleic, fumaric, mesaconic, or citraconic acid, or from carboxylic acid anhydrides, such as maleic anhydride, or one chosen from among ethylene unsaturated monomers with a sulfonic function in the acidic or salified state, and preferentially from among acrylamido-2-methyl-2-propane-sulfonic acid, sodium methallylsulfonate, sulfonic vinyl acid, and sulfonic styrene acid, or from among ethylene unsaturated monomers with a phosphoric function in the acidic or salified state, and preferentially from among phosphoric vinyl acid, ethylene glycol methacrylate phosphate, propylene glycol methacrylate phosphate, ethylene glycol acrylate phosphate, propylene glycol acrylate phosphate, and their ethoxylates, or from among ethylene unsaturated monomers with a phosphonic function in the acidic or salified state, and is preferentially phosphonic vinyl acid, or mixtures thereof,
b) at least one cationic monomer chosen from among quaternary ammoniums, and preferentially from among [2-(methacryloyloxy)ethyl] trimethyl ammonium sulfate or chloride, [2-(acryloyloxy)ethyl] trimethyl ammonium sulfate or chloride, [3-(acrylamido) propyl] trimethyl ammonium sulfate or chloride, dimethyl diallyl ammonium sulfate or chloride, [3-(methacrylamido) propyl] trimethyl ammonium sulfate or chloride, or mixtures thereof,
c) potentially at least one non-ionic monomer chosen from among N-[3-(dimethylamino) propyl] acrylamide or N-[3-(dimethylamino) propyl]methacrylamide, unsaturated esters such as N-[2-(dimethylamino) ethyl]methacrylate, or N-[2-(dimethylamino) ethyl] acrylate; or from among acrylamide or methacrylamide and mixtures thereof, alkyl acrylates or methacrylates, vinyls, and preferentially vinyl acetate, vinylpyrrolidone, styrene, alphamethylstyrene and their derivatives, or formula (I) monomers: 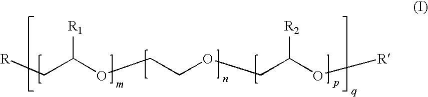
in which:
m and p represent a number of alkylene oxide units less than or equal to 150,
n represents a number of ethylene oxide units less than or equal to 150,
q represents an integer greater than or equal to 1, such as 5≦(m+n+p)q≦150, and preferentially one such as 15≦(m+n+p)q≦120,
R₁ represents hydrogen or the methyl or ethyl radical,
R₂ represents hydrogen or the methyl or ethyl radical,
R represents a radical containing a polymerizable unsaturated function, preferentially belonging to the group of vinyls as well as to the group of acrylic, methacrylic, maleic, itaconic, crotonic, and vinylphtalic esters, as well as to the group of unsaturated urethanes such as acrylurethane, methacrylurethane, α-α′ dimethyl-isopropenyl-benzylurethane, allyl urethane, as well as to the group of allyl or vinyl esters, whether substitutes or not, or to the group of ethylene-unsaturated amides or imides,
R′ represents hydrogen or a hydrocarbon radical with 1 to 40 carbon atoms.

3. A method according to claim 1 one of the claims 1, characterized in that the amphoteric polymers are made up of:
a) at least one anionic monomer, in a proportion of 10% to 90%, preferentially 25% to 75%, and very preferentially 40% to 60% by molar weight,
b) at least one cationic monomer, in a proportion of 10% to 90%, preferentially 25% to 75%, and very preferentially 40% to 60% by molar weight,
c) and at least one non-ionic monomer, in a proportion of 0% to 30%, and preferentially 0% to 20% by molar weight,
the sum of molar weight percentages for each monomer that makes up said amphoteric polymer being equal to 100%.

4. A method according to claim 1, characterized in that the amphoteric polymers are obtained through known radical polymerization methods in solutions, in direct or invert emulsions, in suspensions or through precipitation in appropriate solvents, in the presence of known catalyst systems and transfer agents, or through mediated radical polymerization methods, preferentially through nitroxide-mediated polymerization (NMP) or cobaloxyme-mediated polymerization, atom transfer radical polymerization (ATRP), or sulfur derivative-mediated radical polymerization, said sulfur derivatives being chosen from among carbamates, dithioesters, or trithiocarbonates (RAFT), or xanthates.

5. A method according to claim 1, characterized in that the amphoteric polymers are totally acidic, or totally or partially neutralized by a neutralization agent chosen from among sodium hydroxides, potassium hydroxides, calcium oxides and/or hydroxides, magnesium oxides and/or hydroxides, ammonia, or mixtures thereof, preferentially by a neutralization agent chosen from among sodium hydroxide, potassium hydroxide, ammonia, or mixtures thereof, and very preferentially by a neutralization agent which is ammonia.

6. A method according to claim 1, characterized in that the amphoteric polymers may, potentially before or after their total or partial neutralization, be treated and separated in multiple phases, using static or dynamic methods known to a person skilled in the art, by means of one or more polar solvents that preferentially belong to the group made up of water, methanol, ethanol, propanol, isopropanol, butanols, acetone, tetrahydrofurane, or mixtures thereof.

7. A method according to claim 1, characterized in that the amphoteric polymers are dried.

8. A method according to claim 1, characterized in that the mineral materials are chosen from among natural or precipitated calcium carbonate and talc, said calcium carbonate and talc potentially being chemically and/or mechanically modified, dolomites, kaolin, gypsum, lime, magnesium, titanium dioxide, satin white, aluminum trioxide or aluminum trihydroxide, silicas, mica, barium carbonate, barium sulfate, and any mixtures thereof, such as talc-calcium carbonate, calcium carbonate-kaolin, or mixtures of calcium carbonate with aluminum trihydroxide or aluminum trioxide, or mixtures with synthetic or natural fibers or mineral costructures such as talc-calcium carbonate or talc-titanium dioxide costructures, or mixtures thereof, and preferentially in that they are chosen from among natural or precipitated calcium carbonate and talc, said calcium carbonate and talc potentially being chemically and/or mechanically modified, or mixtures thereof, and in that these mineral materials are very preferentially talc, potentially chemically and/or mechanically modified.

9. Treated mineral materials, characterized in that the agent for treating said mineral materials is an amphoteric polymer, made up of:
a) at least one anionic monomer,
b) at least one cationic monomer,
c) and potentially at least one non-ionic monomer.

10. Treated mineral materials in accordance with claim 9, characterized in that the amphoteric polymer is made up of:
a) at least one anionic monomer which is an anionic ethylene unsaturated monomer with a monocarboxylic function in the acidic or salified state, chosen from among ethylene unsaturated monomer with a monocarboxylic function, and preferentially from among acrylic, methacrylic, crotonic, isocrotonic, or cinnamic acid, or diacide hemiesters such as C₁-C₄ monoesters of maleic or itaconic acids, or chosen from among ethylene unsaturated monomers with a dicarboxylic function in the acidic or salified state, and preferentially from among itaconic, maleic, fumaric, mesaconic, or citraconic acid, or from carboxylic acid anhydrides, such as maleic anhydride, or one chosen from among ethylene unsaturated monomers with a sulfonic function in the acidic or salified state, and preferentially from among acrylamido-2-methyl-2-propane-sulfonic acid, sodium methallylsulfonate, sulfonic vinyl acid, and sulfonic styrene acid, or from among ethylene unsaturated monomers with a phosphoric function in the acidic or salified state, and preferentially from among phosphoric vinyl acid, ethylene glycol methacrylate phosphate, propylene glycol methacrylate phosphate, ethylene glycol acrylate phosphate, propylene glycol acrylate phosphate, and their ethoxylates, or from among ethylene unsaturated monomers with a phosphonic function in the acidic or salified state, and is preferentially phosphonic vinyl acid, or mixtures thereof,
b) at least one cationic monomer chosen from among quaternary ammoniums, and preferentially from among [2-(methacryloyloxy)ethyl] trimethyl ammonium sulfate or chloride, [2-(acryloyloxy)ethyl] trimethyl ammonium sulfate or chloride, [3-(acrylamido) propyl] trimethyl ammonium sulfate or chloride, dimethyl diallyl ammonium sulfate or chloride, [3-(methacrylamido) propyl] trimethyl ammonium sulfate or chloride, or mixtures thereof,
c) potentially at least one non-ionic monomer chosen from among N-[3-(dimethylamino) propyl] acrylamide or N-[3-(dimethylamino) propyl]methacrylamide, unsaturated esters such as N-[2-(dimethylamino) ethyl]methacrylate, or N-[2-(dimethylamino) ethyl] acrylate; or from among acrylamide or methacrylamide and mixtures thereof, alkyl acrylates or methacrylates, vinyls, and 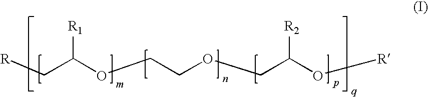
preferentially vinyl acetate, vinylpyrrolidone, styrene, alphamethylstyrene and their derivatives, or formula (I) monomers:
in which:
m and p represent a number of alkylene oxide units less than or equal to 150,
n represents a number of ethylene oxide units less than or equal to 150,
q represents an integer greater than or equal to 1, such as 5≦(m+n+p)q≦150, and preferentially one such as 15≦(m+n+p)q≦120,
R₁ represents hydrogen or the methyl or ethyl radical,
R₂ represents hydrogen or the methyl or ethyl radical,
R represents a radical containing a polymerizable unsaturated function, preferentially belonging to the group of vinyls as well as to the group of acrylic, methacrylic, maleic, itaconic, crotonic, and vinylphtalic esters, as well as to the group of unsaturated urethanes such as acrylurethane, methacrylurethane, α-α′ dimethyl-isopropenyl-benzylurethane, allyl urethane, as well as to the group of allyl or vinyl esters, whether substitutes or not, or to the group of ethylene-unsaturated amides or imides,
R′ represents hydrogen or a hydrocarbon radical with 1 to 40 carbon atoms.

11. Treated mineral materials according to claim 9, characterized in that said amphoteric polymers is made up of:
a) at least one anionic monomer, in a proportion of 10% to 90%, preferentially 25% to 75%, and very preferentially 40% to 60% by molar weight,
b) at least one catonic monomer, in a proportion of 10% to 90%, preferentially 25% to 75%, and very preferentially 40% to 60% by molar weight,
c) and at least one non-ionic monomer, in a proportion of 0% to 30%, and preferentially 0% to 20% by molar weight,
the sum of molar weight percentages for each monomer that makes up said amphoteric polymer being equal to 100%.

12. Treated mineral materials according to claim 9, characterized in that the amphoteric polymers are obtained through known radical polymerization methods in solutions, in direct or invert emulsions, in suspensions or through precipitation in appropriate solvents, in the presence of known catalyst systems and transfer agents, or through mediated radical polymerization methods, preferentially through nitroxide-mediated polymerization (NMP) or cobaloxyme-mediated polymerization, atom transfer radical polymerization (ATRP), or sulfur derivative-mediated radical polymerization, said sulfur derivatives being chosen from among carbamates, dithioesters, or trithiocarbonates (RAFT), or xanthates.

13. Treated mineral materials according to claim 9, characterized in that the amphoteric polymers are totally acidic, or totally or partially neutralized by a neutralization agent chosen from among sodium hydroxides, potassium hydroxides, calcium oxides and/or hydroxides, magnesium oxides and/or hydroxides, ammonia, or mixtures thereof, preferentially by a neutralization agent chosen from among sodium hydroxide, potassium hydroxide, ammonia, or mixtures thereof, and very preferentially by a neutralization agent which is ammonia.

14. Treated mineral materials according to claim 9, characterized in that the amphoteric polymers may, potentially before or after their total or partial neutralization, be treated and separated in multiple phases, using static or dynamic methods known to a person skilled in the art, by means of one or more polar solvents that preferentially belong to the group made up of water, methanol, ethanol, propanol, isopropanol, butanols, acetone, tetrahydrofurane, or mixtures thereof.

15. Treated mineral materials according to claim 9, characterized in that the amphoteric polymers are dried.

16. Treated mineral materials according to claim 9, characterized in that the mineral materials are chosen from among natural or precipitated calcium carbonate and talc, said calcium carbonate and talc potentially being chemically and/or mechanically modified, dolomites, kaolin, gypsum, lime, magnesium, titanium dioxide, satin white, aluminum trioxide or aluminum trihydroxide, silicas, mica, barium carbonate, barium sulfate, and any mixtures thereof, such as talc-calcium carbonate, calcium carbonate-kaolin, or mixtures of calcium carbonate with aluminum trihydroxide or aluminum trioxide, or mixtures with synthetic or natural fibers or mineral costructures such as talc-calcium carbonate or talc-titanium dioxide costructures, or mixtures thereof, and preferentially in that they are chosen from among natural or precipitated calcium carbonate and talc, said calcium carbonate and talc potentially being chemically and/or mechanically modified, or mixtures thereof, and in that these mineral materials are very preferentially talc, potentially chemically and/or mechanically modified.

17. A dry powder of treated mineral materials, characterized in that said treated mineral materials are those according to claim 9.

18. Granulated treated mineral materials, characterized in that said treated mineral materials are those according to claim 9.

19. An aqueous suspension of treated mineral materials, characterized in that said treated mineral materials are those according to claim 9.

20. An agent for reducing the quantity of undesirable colloids in the process of manufacturing a sheet of paper comprising treated mineral materials according to claim 9.
